(19) United States
(12) Patent Application Publication
(10) Pub. No.: US 2016/0344127 A1
(43) Pub. Date: Nov. 24, 2016

(54) ELECTROCONDUCTIVE MATERIAL WITH AN UNDULATING SURFACE, AN ELECTRICAL TERMINAL FORMED OF SAID MATERIAL, AND A METHOD OF PRODUCING SAID MATERIAL

(71) Applicant: DELPHI TECHNOLOGIES, INC., Troy, MI (US)

(72) Inventors: GEORGE ALBERT DREW, WARREN, OH (US); GINA SACCO, WARREN, OH (US)

(21) Appl. No.: 14/717,304

(22) Filed: May 20, 2015

(51) Int. Cl. H01R 13/03; C23C 4/08; H01R 24/58; C25D 7/00; C25D 5/16; B32B 15/01; C23C 4/12; C23C 24/04

(52) U.S. Cl. CPC H01R 13/035; C23C 4/12; C23C 4/08; C23C 24/04; C25D 7/00; C25D 5/16; B32B 15/01; H01R 24/58

(57) ABSTRACT

An electroconductive material having a base member formed of copper-based material and a coating layer overlaying the base member. The coating layer may be formed of tin-based, nickel-based, copper-based, silver-based, or gold-based materials. An undulate surface of the coating layer defines a plurality of crests and troughs. Each trough in the plurality of troughs has a depth of at least one half micron (0.5 μm) relative to each adjacent crest in the plurality of crests. A distance between adjacent crests in the plurality of crests is between twenty microns (20 μm) and one hundred microns (100 μm). This electroconductive material may form the contact surface of an electrical terminal in an electrical connection component and is effective to improve fretting corrosion resistance. A method of manufacturing such a electroconductive material is also presented.

### TECHNICAL FIELD OF THE INVENTION

The invention relates to an electroconductive material with an undulating surface which is particularly useful for a contact surface of an electrical terminal.

### BACKGROUND OF THE INVENTION

Automotive electrical terminals are commonly coated with a thin layer of tin-based material that may be applied by electroplating, deposition, thermal spray, kinetic spray, etc., hereinafter generically referred to as tin plating. As shown in FIG. 1, the tin plating 1 has a generally uniform thickness as applied to a generally flat contact surface 2 of an electrical terminal 3. The tin plating helps provide a low resistance electrical connection and also provides some corrosion resistance to the underlying substrate 4, which is typically formed of a copper-based material.

Tin plating, is susceptible to a degradation mechanism called fretting corrosion. As shown in FIG. 8, fretting corrosion is a buildup of insulating fretting debris 5 formed of an oxidized tin material on the contact surface 2 that is caused by movement of the oxidized tin material due to relative motion between mating contact surfaces. As the oxidized material is moved, unoxidized tin plating is exposed that after exposure becomes oxidized and then moved as the process is repeated. Vibration and/or thermal cycling are the typical causes of this relative motion between mating contact surfaces. Buildup of this fretting debris causes a rapid increase of electrical resistance between the mating contact surfaces.

There are several methods commonly used to minimize the formation of fretting corrosion on tin plated contacts. One method is using a high contact normal force. This high normal force reduces relative motion between contacts, but has a negative effect on connections by increasing the force needed to plug connections together. Connectors having multiple contacts having a high normal force can easily exceed ergonomic standards for connection force.

Another way to minimize fretting corrosion is to use gold, silver, or other noble metal plating in place of tin plating for contact surfaces. By using noble metals which do not oxidize readily, the fretting debris does not build up an insulating layer as quickly as it does for tin plating. Unfortunately, noble metals plating which are resistant to fretting corrosion are more expensive than tin plating.

A third method to reduce fretting corrosion of tin plated electrical contacts is to add a lubricant layer to the contact surface. This can reduce the formation of insulating fretting debris. Although lubricants can be effective for reducing fretting corrosion, they can add extra processing and cost. Therefore, a terminal that is resistant to fretting corrosion but does not require a high normal force, noble metal plating, or a lubrication is desired.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

In accordance with an embodiment of the invention, an electroconductive material is provided. The electroconductive material includes a base member formed of copper-based material and a coating layer overlaying the base member. The coating layer may be formed of a material that is tin-based, nickel-based, copper-based, silver-based, or gold-based. An undulate surface of the coating layer defines a plurality of crests and troughs. Each trough in the plurality of troughs has a depth of at least one half micron (0.5 μm) relative to each adjacent crest in the plurality of crests. A distance between adjacent crests in the plurality of crests is less than one hundred microns (100 μm). The distance between adjacent crests may be more than twenty microns (20 μm). The plurality of crests and troughs form an irregular pattern or alternatively the plurality of crests and troughs form a regular pattern, such as a pattern of substantially parallel grooves.

The base member may define another undulate surface defining another plurality of crests and troughs underlying the coating layer. The coating layer may be characterized as having a substantially uniform thickness. The plurality of crests and troughs in the coating layer or on the base member may be formed by a manufacturing process such as stamping, embossing, electroplating, thermal spraying, kinetic spraying, 3D printing, stereolithography, powder deposition, and/or ablation.

In accordance with another embodiment, an electrical connection component is provided. The electrical connection component has a male terminal and a female terminal. At least one of the male terminal and the female terminal includes the electroconductive material described supra.

In accordance with yet another embodiment, a method of manufacturing an electroconductive material is provided. The method includes the steps of providing a base member formed of a copper-based material and applying a coating layer over the base member. The coating layer may be formed of a material that is tin-based, nickel-based, copper-based, silver-based, or gold-based material. The method also includes the step of forming an undulate surface in the coating layer defining a plurality of crests and troughs. Each trough in the plurality of troughs has a depth of at least one half micron (0.5 μm) relative to each adjacent crest in the plurality of crests. A distance between adjacent crests in the plurality of crests is less than one hundred microns (100 μm). The distance between adjacent crests may be more than twenty microns (20 μm).

The plurality of crests and troughs may be formed by a process such as stamping, embossing, electroplating, thermal spraying, kinetic spraying, 3D printing, stereolithography, powder deposition, and/or ablation.

The method may further include the step of forming another undulate surface on the base member defining another plurality of crests and troughs. The coating layer in this case is characterized as having a substantially uniform thickness. The plurality of crests and troughs may be formed by a process such as stamping, embossing, electroplating, thermal spraying, kinetic spraying, 3D printing, stereolithography, powder deposition, and/or ablation.

The plurality of crests and troughs may form an irregular pattern or alternatively the plurality of crests and troughs may form a regular pattern, such as a pattern of substantially parallel grooves.

### BRIEF DESCRIPTION OF THE SEVERAL VIEWS OF THE DRAWING

The present invention will now be described, by way of example with reference to the accompanying drawings, in which:

FIG. 1 is perspective cross section view of a contact surface of an electrical terminal according to the prior art;

FIG. 2 is perspective cross section view of a contact surface of an electrical terminal formed of an electroconductive material according to a first embodiment of the invention;

FIG. 3 is perspective cross section view of a contact surface of an electrical terminal formed of an electroconductive material according to a second embodiment of the invention;

FIG. 4 is perspective cross section view of a contact surface of an electrical terminal formed of an electroconductive material according to a third embodiment of the invention;

FIG. 5 is a perspective cross section view of an electrical connection component formed of an electroconductive material according to a first embodiment of the invention according to a fourth embodiment of the invention;

FIG. 6 is a side view of a fretting corrosion test device and a test coupon formed of an electroconductive material according to the first embodiment of the invention shown in FIG. 3;

FIG. 7 is a graph comparing the contact resistance of the contact surface of an electrical terminal according to the prior art shown in FIG. 1 and the contact resistance of the contact surface of an electrical terminal according to a first embodiment of the invention shown in FIG. 2 when exposed to a number of fretting cycles; and

FIG. 8 is a drawing of a photomicrograph of a build-up of oxidized material on a contact surface of an electrical terminal according to the prior art;

FIG. 9 is a drawings of a photomicrograph of a build-up of oxidized material on a contact surface of an electrical terminal according the first embodiment of the invention shown in FIG. 3;

FIG. 10 is a flow chart of a method of manufacturing an electroconductive material according to a fifth embodiment of the invention.

### DETAILED DESCRIPTION OF THE INVENTION

The inventors have discovered that fretting corrosion on plated electrical terminals can be reduced by forming the electrical terminals from an electroconductive material having an undulating pattern in the plating creating crests and troughs in the surface of the plating. Without subscribing to any particular theory of operation, the geometry of the crests and troughs allows fretting debris to be displaced into the troughs or open spaces between the taller crests. The peaks of the taller crests then maintain a lower resistance electrical contact free of fretting debris between the electrical terminals. The spacing between contact spots provided by the crests must be small enough to allow multiple contact spots to make electrical contact. Tests of the electroconductive material have found that this electroconductive material was able to withstand about eight times more fretting cycles before developing unacceptable high contact resistance than a typical tin plated material.

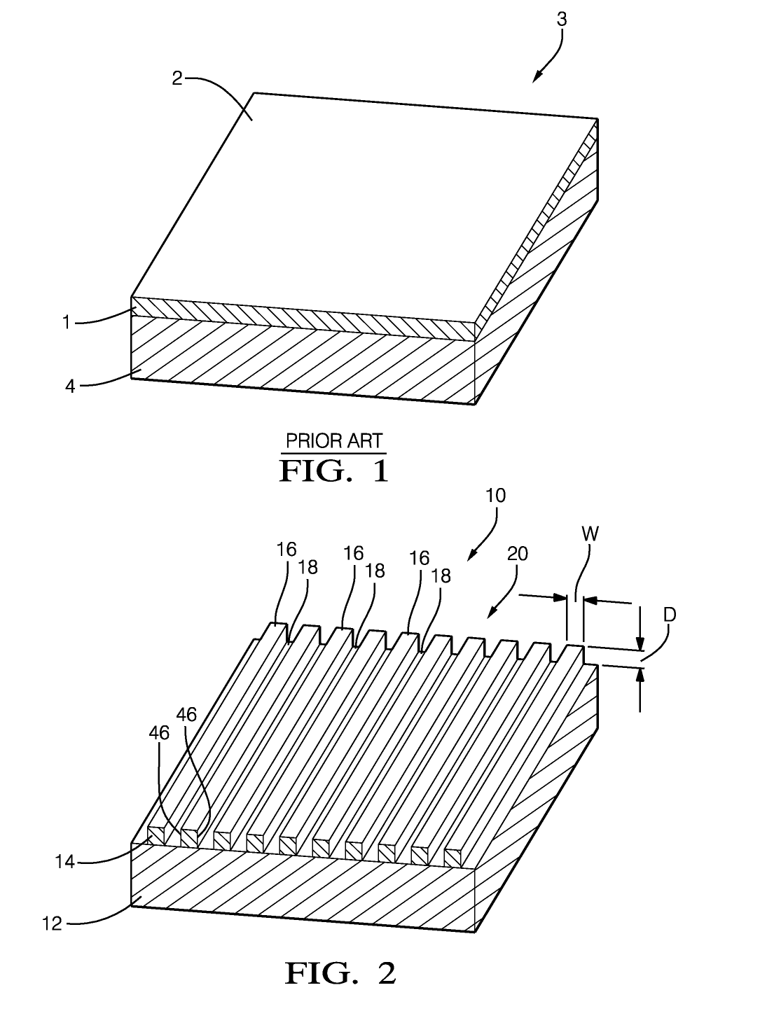

FIG. 2 illustrates a non-limiting example of an electroconductive material 10 suitable for forming a contact surface of an electrical terminal. The base member 12 of the electroconductive material 10 is formed of copper-based material. As used herein, a copper-based material may be a pure copper or a copper alloy wherein copper is the major component by weight. Alternately, the base material may be formed of an aluminum-based material, ferrous-based material, or any other suitable electrically conductive material.

A coating layer 14, or plating, overlays the base member 12. The coating layer 14 may be formed of a tin-based material, nickel-based material, copper-based material, silver-based material, or gold-based material. Alternatively, other conductive materials may be utilized. The coating layer 14 has an undulate surface that defines a plurality of crests 16 and troughs 18. The inventors have observed that fretting corrosion resistance is improved when each trough 18 in the plurality of troughs 18 has a depth of at least one half micron (0.5 μm) relative to each adjacent crest 16 in the plurality of crests 16. The inventors have further observed that fretting corrosion resistance is improved when a distance between adjacent crests 16 in the plurality of crests 16 is less than one hundred microns (100 μm) and the distance between adjacent crests 16 is more than twenty microns (20 μm).

As illustrated in FIG. 2, the plurality of crests 16 and troughs 18 may form a regular pattern, such as a pattern of substantially parallel grooves 20 wherein each groove has a nearly identical depth D and width W as every other groove providing consistent intergroove spacing. The grooves may have a V or U shaped cross section. Alternatively a regular pattern of crests 16 and troughs 18, such as the rhomboid knurl pattern illustrated in U.S. Pat. No. 8,622,774, the entire disclosure of which is hereby incorporated herein by reference, may be used.

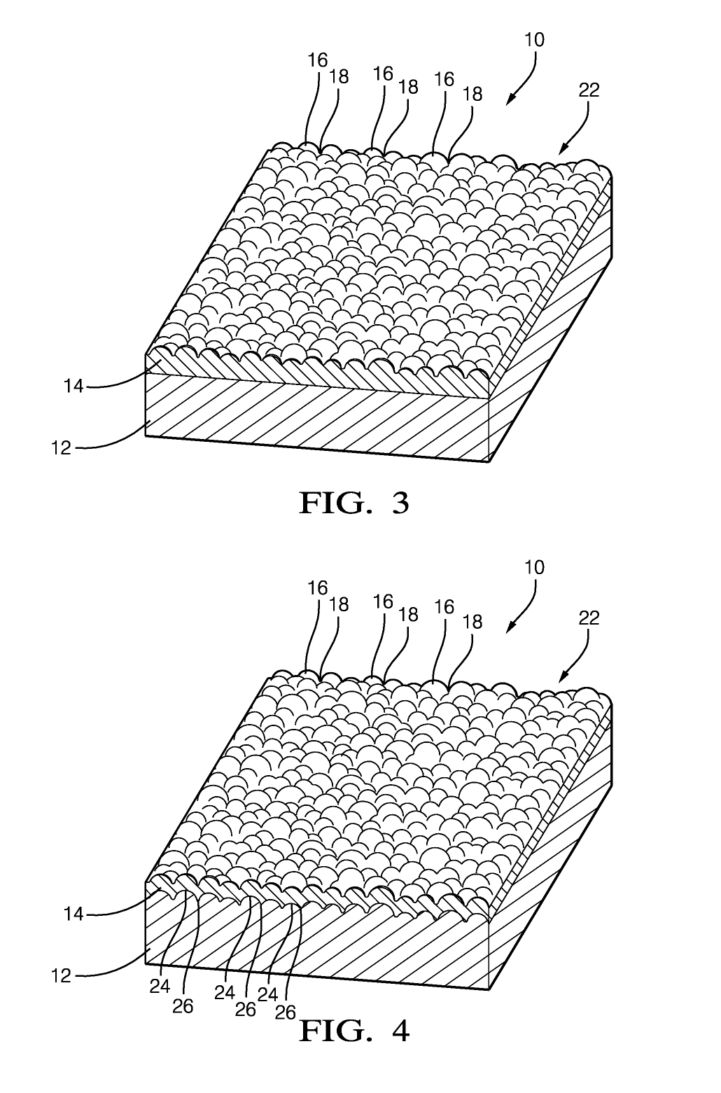

As illustrated in FIG. 3, the plurality of crests 16 and troughs 18 form an irregular pattern 22. The irregular pattern 22 may be formed of irregular grooves having different depths and widths. The irregular pattern 22 may alternatively be formed of an irregular pattern of pits and peaks (not shown). The plurality of crests 16 and troughs 18 may be formed entirely within the coating layer 14 by variations in the thickness of the coating layer 14.

Alternatively, as illustrated in FIG. 4, the coating layer 14 may have a substantially uniform thickness and a plurality of crests 24 and troughs 26 may be formed in an underlying surface in the base member 12 which provide the plurality of crests 16 and troughs 18 in the coating layer 14. While an irregular pattern 22 is shown here, the underlying surface of the base member 12 may alternatively define a regular pattern.

The plurality of crests 16 and troughs 18 are formed by in the coating layer 14 or in the base member 12 by a manufacturing process such as stamping, embossing, electroplating, thermal spraying, kinetic spraying, 3D printing, stereolithography, powder deposition, ablation, or any other manufacturing process known to those skilled in the art.

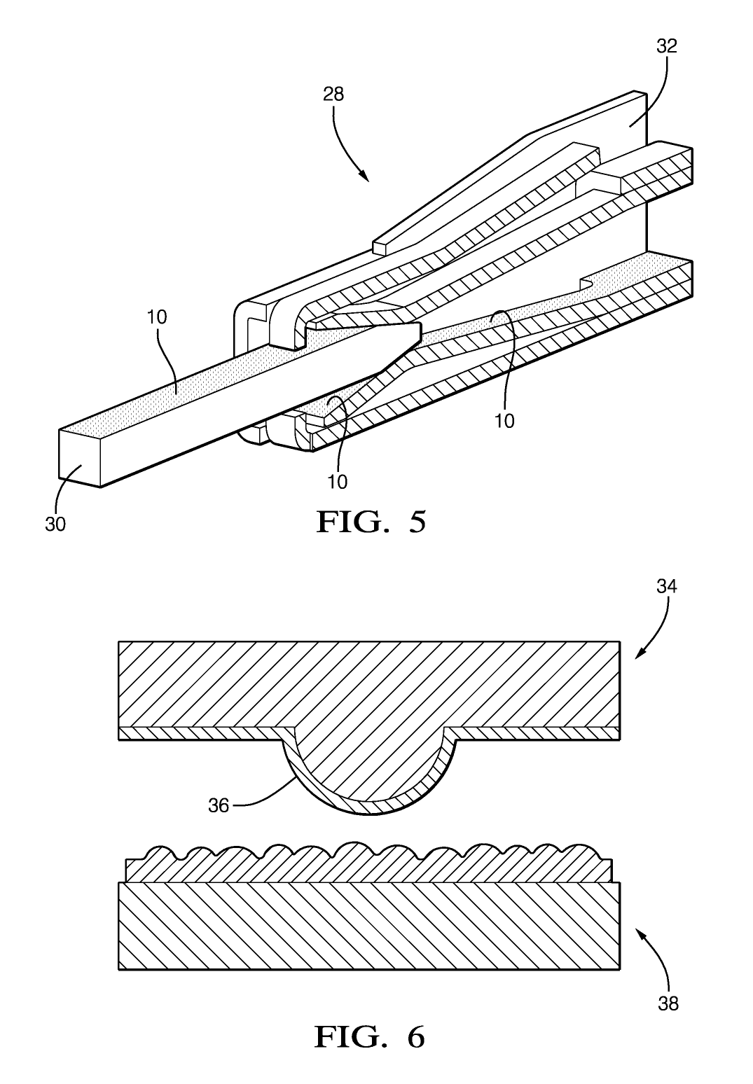

FIG. 5 illustrates a non-limiting example of an electrical connection component 28, having a male terminal 30 and a female terminal 32. At least one of the male terminal 30 and the female terminal 32 include the electroconductive material 10 described above as a contact surface.

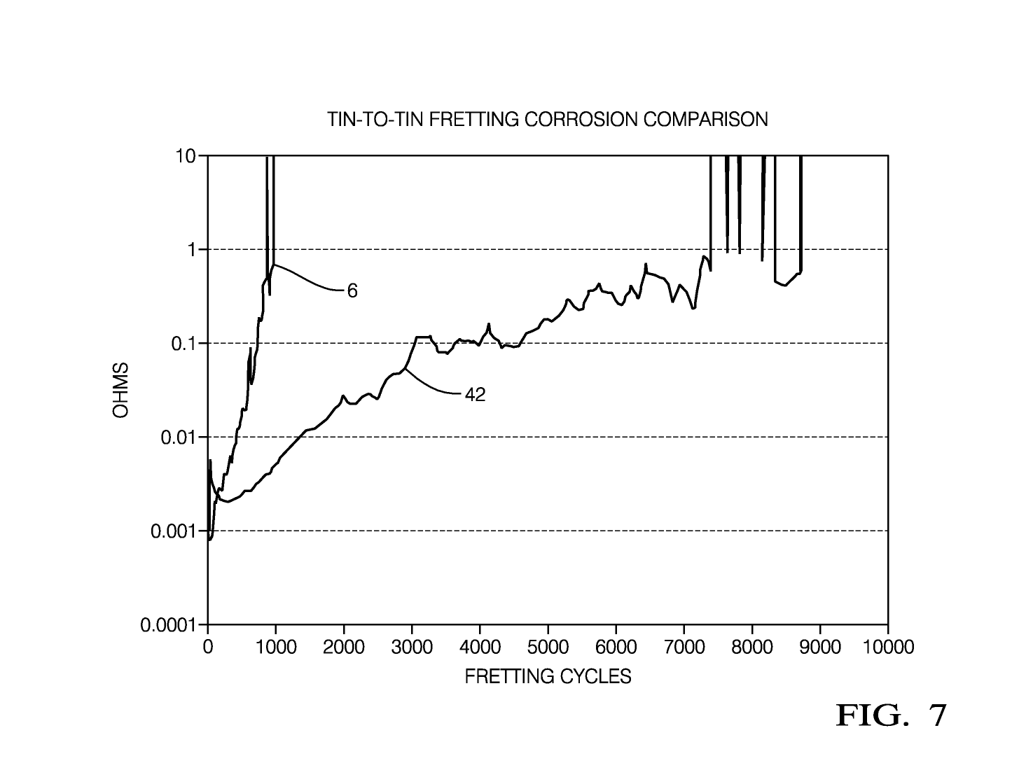

A comparison of fretting corrosion resistance was conducted using a laboratory fretting corrosion simulator to compare the fretting corrosion resistance of a conventional tin-plated material as illustrated in FIG. 1 to the fretting corrosion resistance of the electroconductive material 10 having parallel grooves 20 illustrated in FIG. 2. The second test coupon 42 for the electroconductive material 10 having parallel grooves 20 used the same tin plating as conventional tin-plated material. For each test, a uniformly tin-plated test contact 34 with 1.6 mm radius 36 was rubbed against a test coupon 38 as illustrated in FIG. 6. The testing was conducted by applying a one newton (1N) load to the test contact 34 and vibrating the test contact 34 against the test coupon 38 with a fifty micron (50 μm) amplitude at ten Hertz (10 Hz). The electrical resistance between the test coupon 38 and the test contact 34 was monitored during the testing and the test was judged a failure when the electrical resistance exceeded ten ohms (10Ω). As shown in the graph of the data in FIG. 7, a first test coupon 6 formed of conventional tin-plated material failed the fretting corrosion test after about 900 cycles, while a second test coupon 42 formed the electroconductive material 10 having parallel grooves 20 failed after about 7500 cycles. This result indicates that an electrical terminal 30, 32 utilizing the electroconductive material 10 on the contact surfaces should provide a service life about eight times longer than the conventional tin plated material.

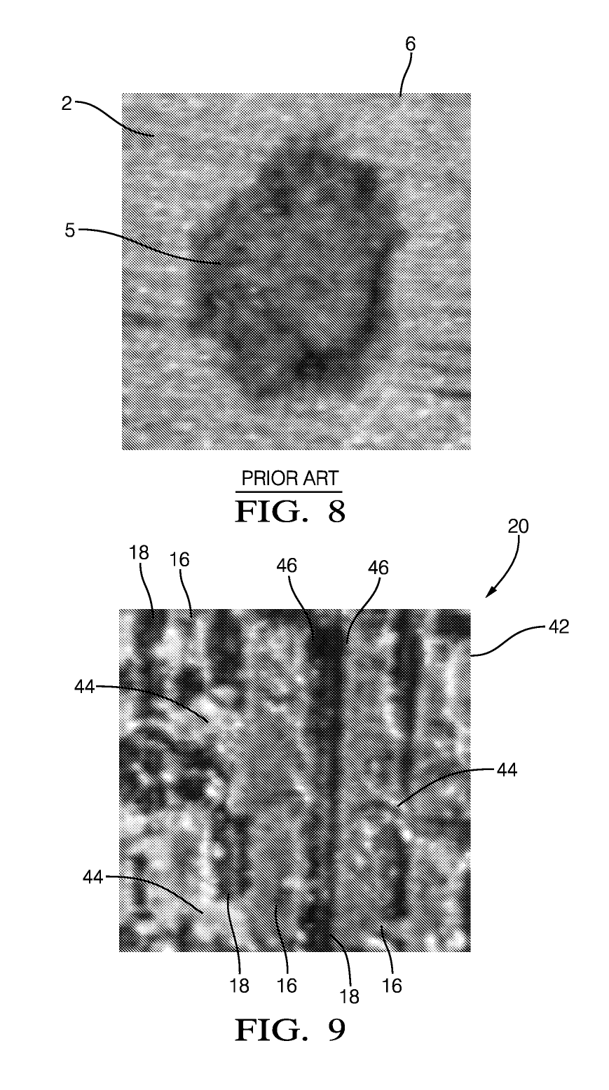

FIGS. 8 and 9 shows photomicrographs of the first test coupon 6 of the conventional tin-plated material and the second test coupon 42 of the electroconductive material 10 having parallel grooves 20, respectively, following the completion of the fretting corrosion testing. As can be seen by comparing the photomicrograph of FIG. 8 to FIG. 9, the fretting debris 5 is concentrated on the first test coupon 6 of the conventional tin plated material shown in FIG. 8 while the fretting debris 44 is scattered on the second test coupon 42 shown in FIG. 9. Without subscribing to any particular theory of operation, the edges 46 of the parallel grooves 20 may break up the fretting debris 44 so that it is not allowed to concentrate as shown in FIG. 8. A portion of the fretting debris 44 is also seen to collect within the troughs 18 of the grooves. The concentration of the more resistive oxidized debris material between the contact surfaces of the electrical terminal causes the contact resistance to increase to unacceptable levels. Breaking up the fretting debris 44 and disposing the fretting debris 44 in the troughs 18 of the grooves provides a larger portion of the contact surface that is not obscured by fretting debris 44.

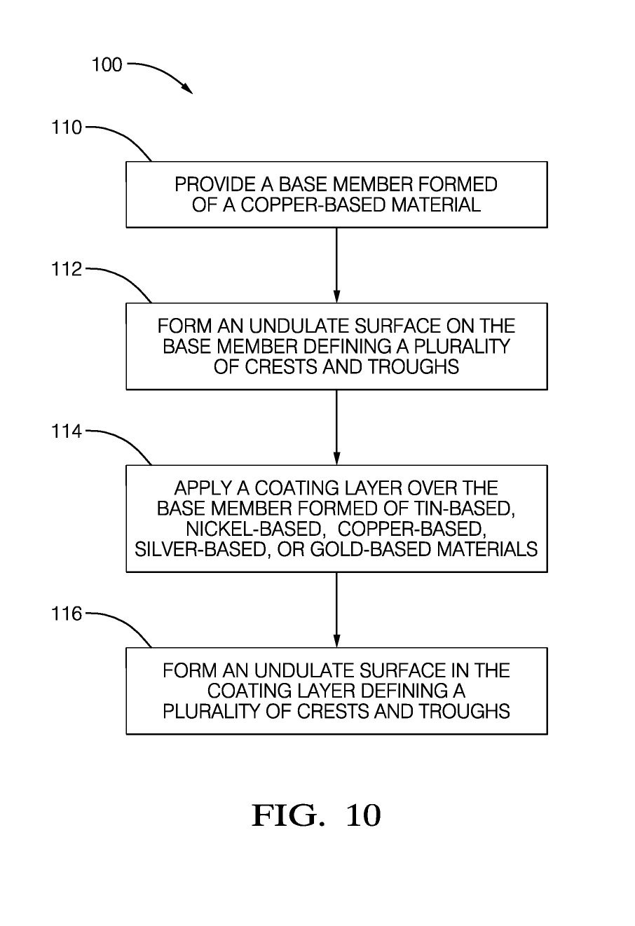

FIG. 10 illustrates a non-limiting example of a method 100 of manufacturing an electroconductive material 10. The method 100 includes the following steps.

STEP 110, PROVIDE A BASE MEMBER FORMED OF A COPPER-BASED MATERIAL, includes providing a base member 12 formed of a copper-based material, for example a sheet of copper-based material.

Optional STEP 112, FORM AN UNDULATE SURFACE ON THE BASE MEMBER DEFINING A PLURALITY OF CRESTS AND TROUGHS, is an optional step that includes forming an undulate surface on the base member 12 defining a plurality of crests 24 and troughs 26. The plurality of crests 24 and troughs 26 are formed by a manufacturing process such as stamping, embossing, electroplating, thermal spraying, kinetic spraying, 3D printing, stereolithography, powder deposition, and/or ablation. Each trough 26 in the plurality of troughs 26 has a depth of at least one half micron (0.5 μm) relative to each adjacent crest 24 in the plurality of crests 24. A distance between adjacent crests 24 in the plurality of crests 24 is less than one hundred microns (100 μm). The distance between adjacent crests 24 is more than twenty microns (20 μm). The plurality of crests 24 and troughs 26 may form a regular pattern, such as a pattern of substantially parallel grooves 20. Alternatively, the plurality of crests 24 and troughs 26 may form an irregular pattern 22. The coating layer 14 is characterized as having a substantially uniform thickness. If performed, STEP 112 precedes STEP 114.

STEP 114, APPLY A COATING LAYER OVER THE BASE MEMBER FORMED OF TIN-BASED, NICKEL-BASED, COPPER-BASED, SILVER-BASED, OR GOLD-BASED MATERIALS, includes applying a coating layer 14 over the base member 12 formed of a material selected from the group consisting of tin-based, nickel-based, copper-based, silver-based, and gold-based materials.

Optional STEP 116, FORM AN UNDULATE SURFACE IN THE COATING LAYER DEFINING A PLURALITY OF CRESTS AND TROUGHS, is an optional step that includes forming an undulate surface in the coating layer 14 defining a plurality of crests 16 and troughs 18. Each trough 18 in the plurality of troughs 18 has a depth of at least one half micron (0.5 μm) relative to each adjacent crest 16 in the plurality of crests 16. A distance between adjacent crests 16 in the plurality of crests 16 is less than one hundred microns (100 μm). The distance between adjacent crests 16 is more than twenty microns (20 μm). The plurality of crests 16 and troughs 18 are formed by a manufacturing process such as stamping, embossing, electroplating, thermal spraying, kinetic spraying, 3D printing, stereolithography, powder deposition, and/or ablation. The plurality of crests 16 and troughs 18 may form a regular pattern, such as a pattern of substantially parallel grooves 20. Alternatively, the plurality of crests 16 and troughs 18 may form an irregular pattern 22. STEP 116 may or may not be performed if STEP 112 is performed.

The electroconductive material 10 formed by the method 100 described herein may be a sheet of material that is then stamped and folded to form an electrical contact. Alternatively, the electroconductive material 10 may be formed on a pre-fashioned electrical contact.

Accordingly an electroconductive material 10 suitable for forming electrical contacts and a method 100 of manufacturing such a material is provided. This electroconductive material 10 provides the benefits of reducing fretting corrosion with a tin based plating material rather than higher cost plating materials such as noble metals like gold or silver. Fretting corrosion resistance can be enhanced without increasing terminal contact force. In fact, by using the electroconductive material 10, terminal contact force could be reduced while still providing an acceptable level of fretting corrosion resistance. This is particularly desirable to meet ergonomic plug in force requirements for electrical connection systems.

The electroconductive material 10 can be combined with other fretting mitigation methods, like lubricants or noble metal plating for even more resistance to fretting corrosion. The electroconductive material 10 further provides a benefit with lubricants since they will collect in the troughs 18 of the electroconductive material 10 to minimize lubricant migration. This electroconductive material 10 may be manufactured using a variety of manufacturing processes, including stamping, embossing, electroplating, thermal spray, kinetic spray, 3D printing, stereolithography, powder deposition, or ablation methods. Conventional electroplating can also be applied over a pre-formed surface of crests 24 and troughs 26 in the base member 12 to make the desired plurality of crests 16 and troughs 18 in the coating layer 14.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. An electroconductive material, comprising:
a base member formed of copper-based material; and
a coating layer overlaying the base member formed of a material selected from the group consisting of tin-based, nickel-based, copper-based, silver-based, and gold-based materials, wherein an undulate surface of the coating layer defines a plurality of crests and troughs, wherein each trough in the plurality of crests and troughs has a depth of at least one half micron (0.5 μm) relative to each adjacent crest in the plurality of crests, and wherein a distance between adjacent crests in the plurality of crests is less than one hundred microns (100 μm).

2. The electroconductive material according to claim 1, wherein the distance between adjacent crests is more than twenty microns (20 μm).

3. The electroconductive material according to claim 1, wherein the plurality of crests and troughs form an irregular pattern.

4. The electroconductive material according to claim 1, wherein the plurality of crests and troughs form a regular pattern.

5. The electroconductive material according to claim 4, wherein the plurality of crests and troughs form a pattern of substantially parallel grooves.

6. The electroconductive material according to claim 1, wherein the base member defines another undulate surface defining another plurality of crests and troughs underlying the coating layer and wherein the coating layer is characterized as having a substantially uniform thickness.

7. The electroconductive material according to claim 1, wherein the plurality of crests and troughs are formed by a manufacturing process selected from the group consisting of stamping, embossing, electroplating, thermal spraying, kinetic spraying, 3D printing, stereolithography, powder deposition, and ablation.

8. An electrical connection component, comprising:
a male terminal; and
a female terminal, wherein at least one of the male terminal and the female terminal comprise the electroconductive material according to claim 1.

9. A method of manufacturing an electroconductive material, comprising the steps of:
providing a base member formed of a copper-based material;
applying a coating layer over the base member formed of a material selected from the group consisting of tin-based, nickel-based, copper-based, silver-based, and gold-based materials; and
forming an undulate surface in the coating layer defining a plurality of crests and troughs, wherein each trough in the plurality of crests and troughs has a depth of at least one half micron (0.5 μm) relative to each adjacent crest in the plurality of crests, and wherein a distance between adjacent crests in the plurality of crests is less than one hundred microns (100 μm).

10. The method of manufacturing an electroconductive material according to claim 9, wherein the plurality of crests and troughs are formed by a process selected from the group consisting of stamping, embossing, electroplating, thermal spraying, kinetic spraying, 3D printing, stereolithography, powder deposition, and ablation.

11. The method of manufacturing an electroconductive material according to claim 9, further comprising the step of:
forming another undulate surface on the base member defining another plurality of crests and troughs, wherein the coating layer is characterized as having a substantially uniform thickness.

12. The method of manufacturing an electroconductive material according to claim 9, wherein the distance between adjacent crests is more than twenty microns (20 μm).

13. The method of manufacturing an electroconductive material according to claim 9, wherein the plurality of crests and troughs form an irregular pattern.

14. The method of manufacturing an electroconductive material according to claim 9, wherein the plurality of crests and troughs form a regular pattern.

15. The method of manufacturing an electroconductive material according to claim 14, wherein the plurality of crests and troughs form a pattern of substantially parallel grooves.
